(19) United States
(12) Patent Application Publication
(10) Pub. No.: US 2006/0070413 A1
(43) Pub. Date: Apr. 6, 2006

(54) Detent latching system

(76) Inventors: Robert Mehmen, Shell Rock, IA (US); Daniel Jackson, Center Rock, IA (US); Fred Ritchie, Cedar Falls, IA (US); Deonna Fritz, Cedar Falls, IA (US)

Correspondence Address: CALFEE HALTER & GRISWOLD, LLP, 800 SUPERIOR AVENUE, SUITE 1400, CLEVELAND, OH, 44114, US

(21) Appl. No.: 11/157,088

(22) Filed: Jun. 20, 2005

Related U.S. Application Data
(60) Provisional application No. 60/521,696, filed on Jun. 18, 2004.

(51) Int. Cl. E05B 65/00

(52) U.S. Cl. 70/93

(57) ABSTRACT

A latching system that is comprised of a detent assembly and a securing plate. The detent assembly is comprised of a detent and a biasing member, which biases the detent in a first direction. The securing plate includes a curvilinear portion. The curvilinear portion is comprised of a detent traveling portion and a detent securing portion, which is located proximate to the detent traveling portion. The detent traveling portion is adapted to engage the detent and encourage the detent towards a second direction, which is approximately opposite of the first direction, upon engagement with the detent. When the detent is in contact with the detent securing portion, the detent assembly is reversibly secured relative to the securing plate.

### CROSS-REFERENCE TO RELATED PATENT APPLICATION

This application claims the benefit of U.S. Provisional Patent Application No. 60/521,696 filed on Jun. 18, 2004, the specification of which is hereby incorporated in its entirety.

### FIELD OF INVENTION

The present invention relates generally to a latching system for doors and drawers. More particularly, the present invention relates to a detent latching system for the latching of doors and drawers.

### BACKGROUND OF THE INVENTION

Doors, drawers, and other enclosing members are employed in a variety of ways to accomplish many functions. Doors are typically used to enclose and conceal the interior of cabinets, cupboards, or other such enclosures and enclosable areas. Normally a door is opened and closed by rotating about a set of hinges or by sliding along a track. Drawers are typically used to organize and conceal various items in a neat and orderly fashion within a cabinet, dresser, or other such enclosures and enclosable areas. Normally a drawer is opened and closed by sliding into and out of an enclosure along a set of tracks. Often doors and drawers remain unsecured when in the closed position and are able to open freely. Accordingly, if an enclosure with an unsecured door or drawer is moved, the door or drawer may open during such movement, which may be undesirable. Alternatively, doors and drawers may be secured when in the closed position through the use of latching or locking devices that must be manually disengaged before the door or drawer can be opened.

A typical use of cabinets with door and drawers is garage storage units. Garage storage units usually have multiple spaces, shelves, and other storage areas enclosed by doors, drawers, and other such enclosing members. These multiple spaces allow for storage of items typically kept in a garage, such as tools, spare parts, cleaning agents, and cleaning clothes. Often these garage storage units are mounted on wheels to allow for easy relocating of the storage unit within the garage. This frequent movement can cause for hazardous conditions as unsecured doors and drawers can open freely during relocation, which can cause tools, cleaning agents, etc. to fall or spill out of the storage cabinet.

It is desirable to develop a device or system that ensures doors and drawers remain in a closed position without the use of latching or locking devices that must be separately and manually disengaged before the door or drawer can be opened. In addition, it is desirable to create a device or system that can be disengaged by simply exerting a sufficient opening force upon the door or drawer. Finally, it is desirable to develop a door or drawer securing device or system that allows the door or drawer to be opened and closed smoothly without requiring excessive or abrupt force.

### SUMMARY OF THE INVENTION

A latching system that is comprised of a detent assembly and a securing plate. The detent assembly is comprised of a detent and a biasing member, which biases the detent in a first direction. The securing plate includes a curvilinear portion. The curvilinear portion is comprised of a detent traveling portion and a detent securing portion, which is located proximate to the detent traveling portion. The detent traveling portion is adapted to engage the detent and encourage the detent towards a second direction, which is approximately opposite of the first direction, upon engagement with the detent. When the detent is in contact with the detent securing portion, the detent assembly is reversibly secured relative to the securing plate.

### BRIEF DESCRIPTION OF THE DRAWINGS

The detent latching system of the present invention may be more readily understood by reference to the following drawings. While certain embodiments are shown as illustrative examples of the door and drawer securing device, the scope of this application should not be construed as limited to these illustrative examples.

FIG. 1 is a perspective view of an embodiment of a detent latching system;

FIG. 2 is an elevated view of a detent assembly of the detent latching system shown in FIG. 1;

FIG. 3 is a top view of the detent assembly shown in FIG. 2;

FIG. 4 is a bottom view of the of the detent assembly shown in FIG. 2;

FIG. 5 is a cross-sectional view of the detent assembly shown in FIG. 2, taken along the line 5-5 shown in FIG. 3;

FIG. 6 is a top view of the securing plate of the detent latching system shown in FIG. 1;

FIG. 7 is a sectional view of the detent latching system shown in FIG. 1 mounted to a door and cabinet with the door in an open position;

FIG. 8 is a sectional view of the detent latching system shown in FIG. 1 mounted to a door and cabinet with the door in the closed position;

FIG. 9 is a sectional view of the detent latching system shown in FIG. 1 mounted to a drawer and cabinet with the drawer in the open position;

FIG. 10 is a sectional view of the detent latching system shown in FIG. 1 mounted to a drawer and cabinet with the drawer in the closed position;

FIG. 11 is a top view of a detent assembly with an extended bottom panel; and

FIG. 12 is a bottom view of a detent assembly with an extended bottom panel.

### DETAILED DESCRIPTION

While the described embodiments herein are presented in the context of a detent latching system for doors and drawers, those skilled in the art will readily appreciate that the present invention may be used to latch a variety of different components and items. The examples presented in this disclosure are intended to illustrate the broad application of the invention for a detent latching system. The specific design and operation of the detent latching system selected provide no limitations on the present invention.

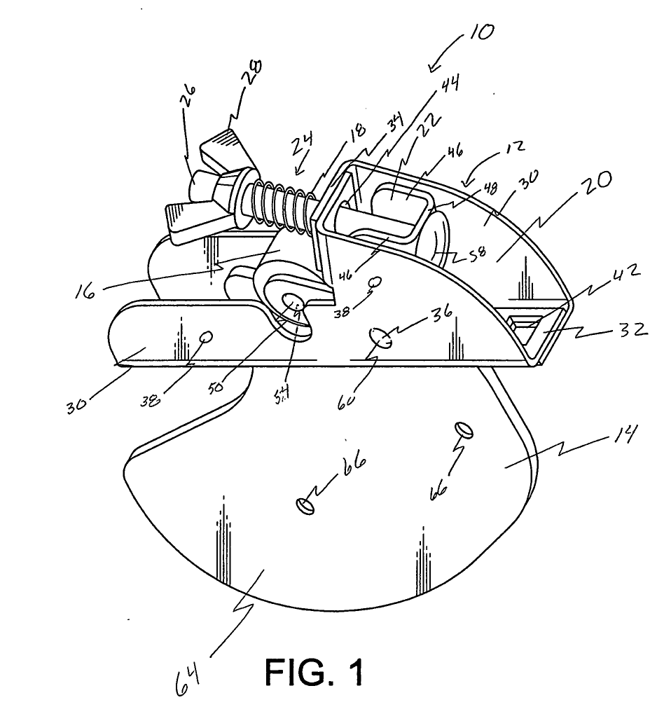

Referring to FIG. 1, a detent latching system 10 is comprised of a detent assembly 12 and a locating or securing plate 14. In this embodiment of a detent latching system 10, the securing plate 14 is designed and arranged to engage with the detent assembly 12.

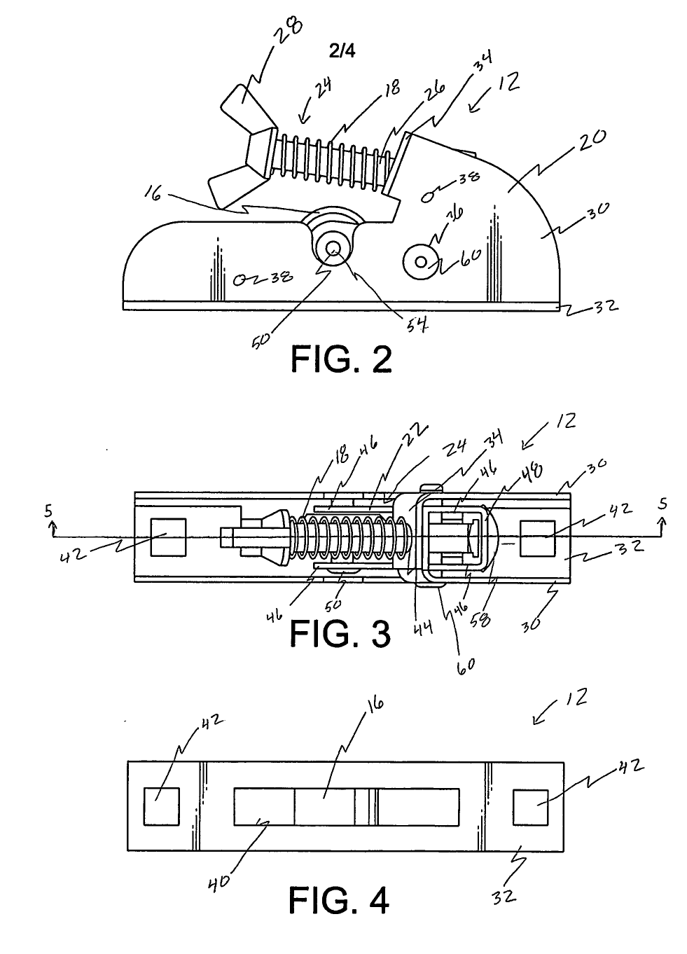

FIGS. 2 through 5 illustrate the detent assembly 12 in greater detail. The detent assembly 12 includes a detent 16, biasing member 18, a housing 20, and a support member 22. In the illustrated embodiment, the detent 16 takes the form of a cylindrical roller 16 and the biasing member 18 takes the form of a coil spring 18. The spring is a component of a biasing assembly 24, which further includes a bolt 26 and a wing nut 28. The housing includes a pair of side panels 30 (best seen in FIG. 2), a bottom panel 32 (best seen in FIG. 4), and a face plate 34 (best seen in FIG. 3), which together form a partially enclosed space. The side panels 30 include a hinge pin opening 36 and a pair of fastener openings 38; the bottom panel 32 includes a detent access opening 40 and a pair of fastener opening 42; and the face plate includes an aperture 44. The housing 20 is typically formed out of metal or plastic, although other suitable materials may also be used. The support member includes two parallel L-shaped walls 46 connected by a connector wall 48.

The detent 16 is attached to the pair of L-shaped walls 46 of the support member 22 by an axle pin 50, which passes through a central passage in the detent 52 and through apertures 54 located in each L-shaped wall 46. In this embodiment the configuration and arrangement of the detent 16 and the axle pin 50 allows for the detent 16 to rotate about the axle pin 50. The biasing assembly 24 is in contact with the support member 22 through the bolt 26. The bolt 26 passes through an aperture in the connector wall 56 so that the head 58 of the bolt 26 is in contact with the connector wall 46, as best seen in FIG. 5. The bolt 26 also passes through the aperture 44 in the face plate 34. As can be best seen in FIG. 2, the spring 18 is mounted onto the shaft of the bolt 26 with one end in contact with the face plate 34 and the other end in contact with the wing nut 28, which is positioned on a threaded portion of the bolt 26 opposite the head 58 of the bolt 26. The spring 18 is preferably in compression when mounted between the face plate 34 and the wing nut 28. The amount the spring 18 is compressed can be adjusted by moving the position of the wing nut 28 relative to the bolt 26.

The L-shaped walls 46 of the support member 22 are coupled to the housing 20 by a hinge pin 60 which passes through the hinge pin opening 36 in the side panels 30 and through apertures 62 in the L-shaped walls 46. The hinge pin 60 and the L-shaped walls 46 are arranged in a manner to allow for rotation of the support member 22 relative to the side panels 30 of the housing 20. In the illustrated embodiment, the hinge pin 60 is a rivet; however, those skilled in the art would readily recognize that other hinging mechanisms could be used. For example, cotter pins, nut and bolt assemblies, and inter-engaging tabs and slots could be utilized.

In the embodiment illustrated in FIGS. 2 through 5, the compression in the mounted spring 18 causes a force to be transferred from the head of the bolt 58 to the connector wall 46 of the support member 22. This force encourages the support member 22 to rotate counterclockwise about the hinge pin 60 and encourages contact between the upper portion of the L-shaped walls 46 and the face plate 34. The force that is generated by the compressed spring 18 is controlled by the positioning of the wing nut 28. The closer the wing nut 28 is positioned to the head of the bolt 58 the more compressed the spring 18, which leads to greater force applied to the connector wall 46. The detent assembly 12 will remain in this state of rest until forces act upon the detent assembly 12, particularly forces acting on the detent 16, change this state of rest.

The detent assembly 12 is designed to allow the biasing member 18 to interact with the detent 16 through the support member 22. When a force is applied to the detent 16 that encourages the detent 16 to move upward (with respect to FIG. 5) the support member 22 is encouraged to rotate clockwise about the hinge pin 60 (again, with respect to FIG. 5). This clockwise rotation is resisted by the spring 18. The clockwise rotation causes the spring 18 to compress further between the face plate 34 and the wing nut 28, which results in a force, applied by the head 58 of the bolt 26 to the connector wall 46, that encourages the support member 22 to rotate counterclockwise. When a force encouraging the detent 16 upward is greater than the force applied by the spring 18 to the support member 22 (through the head 58 of the bolt 26), the support member 22 will rotate clockwise. When the force applied by the spring 18 is greater than the force applied to the detent 16, the support member 22 will rotate counterclockwise. The rotation of the support member 22 serves to move the position of the detent 16 with respect to the housing 20.

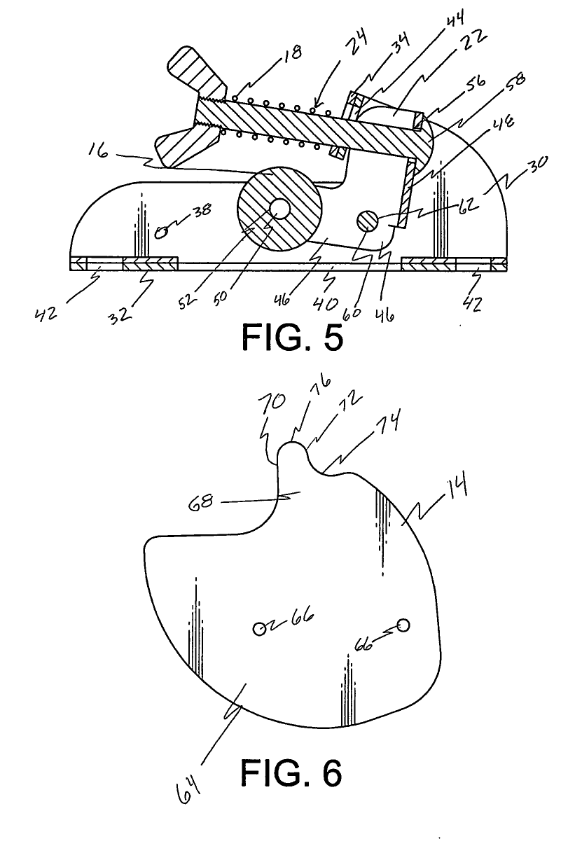

FIG. 6 illustrates an embodiment of the locating or securing plate 14. The plate has a main portion 64, which includes two apertures 66, and an engagement portion 68. The outer perimeter of the engagement portion forms a curvilinear path or portion 70. This curvilinear path 70 is divided into a detent traveling portion 72 and a detent securing portion 74.

The engagement portion 68 of the securing plate 14 is adapted to pass through the detent access opening 40 in the bottom panel 32 of the housing 20 and engage the detent 16. Generally, as the engagement portion 68 passes through the detent access opening 40 the detent 16 traveling portion 72 encounters and engages the detent 16. This encounter encourages the detent 16 to move upward (relative to FIG. 5). As the securing plate 14 continues to pass through the detent access opening 40, the detent 16 proceeds to move along the detent traveling portion 72. The curvilinear nature of the traveling portion 72 causes the maximum rotation of the support member 22 to occur when the detent is in contact with the traveling portion 72 near the peak 76 of the traveling portion 72. As the securing plate 14 is advanced through the detent access opening 40, the detent 16 proceeds to move across the peak 76 of the traveling portion 72 and towards the detent securing portion 74. Once the detent 16 passes the peak 76 of the traveling portion 72, the support member 22 is encouraged to rotate counterclockwise towards its state of rest. This rotation is further encouraged by the compressed spring 18. As the detent 16 encounters the detent securing portion 74 of the securing plate 14, the position of the detent 16 and support member 22 is substantially the same as when the detent assembly 12 is at a state of rest. Locating the detent 16 in contact with the securing portion 74 of the securing plate 14 secures the detent assembly 12 with respect to the securing plate 14.

Once the detent assembly 12 is secured relative to the securing plate 14, the securement can be reversed by withdrawing the securing plate 14 from the detent access opening 40. As a force is applied to the securing plate 14 to withdraw the plate 14 through the detent access opening 40, the detent 16 proceeds to move away from the securing portion 74 of the curvilinear path 70 and back along the traveling portion 72 of the curvilinear path 70. This process causes the support member 22 to rotate clockwise and compress the spring 18. As the detent 16 passes the peak 76 of the traveling portion 72, the support member 22 begins to rotate counterclockwise and the spring 18 further encourages the withdrawal of the securing plate 14 from the detent access opening 40.

In the exemplary embodiment illustrated, the detent 16 is able to roll or rotate as it moves along the traveling portion 72 of the curvilinear path 70. This can facilitate ease of movement along the traveling portion 72, but is not a necessary function of the invention. The detent 16 can be configured to eliminate any rolling, causing the detent 16 to slide along the traveling portion 72. This configuration may actually be preferable for certain embodiments. An embodiment may rely on friction between the detent 16 and securing plate 14 to increase the force needed to cause movement of the detent 14 along the traveling portion 72 when the detent 16 is engaged with the securing plate 14.

The curvilinear nature of the perimeter of the engagement portion 68 of the securing plate 14 serves to enable a smooth engagement and disengagement of the securing plate 14 and the detent 16. As the securing plate 14 is moved relative to the detent assembly 12 and the detent 16 moves along the traveling portion 72, the curvilinear nature of the perimeter of the securing plate 14 changes the forces applied between the detent 16 and the securing plate 14 in a gradual and smooth manner. This lessens the tactile sense perceived by an operator that an excessive force or a sudden thrust or abrupt force is needed to secure or unsecure the detent 16 relative to the securing plate 14.

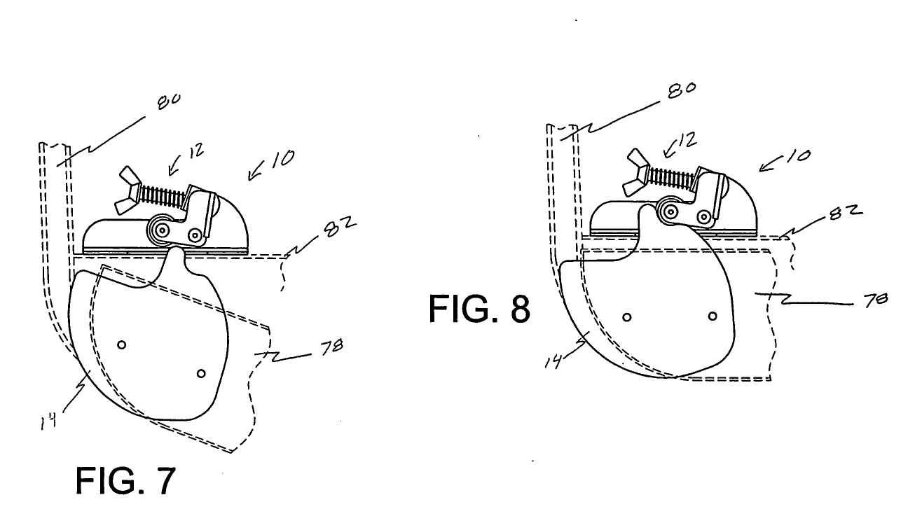

The detent latching system can be utilized in cooperation with a door or a drawer. Referring to FIG. 7, a detent latching system 10 can be seen applied to a door 78 and a cabinet 80. The detent assembly 12 is coupled to a door jam 82 in the cabinet by fasteners passing through the fastener openings 42 in the bottom plate 32 of the housing 20. The securing plate 14 is coupled to the door 78, near the hinged edge of the door, through the fastener openings 66 in the main portion 64 of the securing plate 14. A slot (not shown) is included in the door jam 82 that coincides with the detent access opening 40. The securing plate 14 and detent assembly 12 are arranged so that as the door 78 is closed, by a closing force, the engagement portion 68 of the securing plate 14 passes through the slot in the door jam 82 and through the detent access opening 40 to engage the detent 16. As the door 78 is further closed by the closing force, the detent 16 moves along the traveling portion 72 of the curvilinear path 70 and comes to rest in the securing portion 74 as the door 78 is fully closed. When the detent 16 comes to rest in the securing portion 74, the detent 16 is secured relative to the securing plate 14, as shown in FIG. 8. The detent assembly 12 is coupled to the door jam 82 of the cabinet 80 and the securing plate 14 is coupled to the door 78. Consequently, securing the detent 16 relative to the securing plate 14 serves to hold the door 78 in the closed position until a force is applied to the door 78 to change this state.

Once the door 78 is in the closed position, the door 78 can be move back to the open position, as shown in FIG. 7, by simply applying an opening force to the door 78 itself or through a handle or other similar device (not shown). As the door 78 is pulled open, the detent 16 will move back along the traveling portion 72 of the curvilinear path 70. The curvilinear nature of the perimeter of the engagement portion 68, in cooperation with the spring 18, will provide a gradually changing resisting force, which can be overcome by applying a gradually increasing opening force to the door handle or other such device. Once the detent 16 moves past the peak 76 of the traveling portion 72, the force provided by the spring 18 adds to the opening force. The interaction of the curvilinear perimeter of the engagement portion 68 and the spring 18 provide for a smooth opening of the door without the need for excessive or abrupt force to be applied to the door 78.

The amount of force needed to open and close the door 78 is dependent on the configuration of the biasing member or spring 18. The greater the biasing force applied to the detent 16 by the spring 18, the greater the force needed to either open or close the door 78 of the cabinet 80. Referring to FIG. 2, the biasing force is adjusted by controlling the placement of the wing nut 28 on the bolt 26. As the wing nut 28 is positioned closer to the face plate 34, thus causing greater compression in the spring 18, the force the spring 18 applies to the detent 16 (through the support member 22) becomes larger. Conversely, as the position of the wing nut 26 becomes farther from the face plate 34, thus causing less compression in the spring 18, the force the spring 18 applies to the detent 16 lessens. Therefore, the placement of the wing nut 28 adjusts the biasing force applied to the detent 16. In order to open or close the door of a cabinet, the biasing force applied to the detent 16 needs to be overcome. One reason for adjusting the biasing force is to account for the items stored in a cabinet. If the items are heavy or dangerous, the biasing force can be increased to lessen the chances the items will inadvertently open the door by falling against a door as a cabinet is moved. If the items in the cabinet are light weight, the biasing force can be lessened to make it easier for a user to open and close a door of a cabinet.

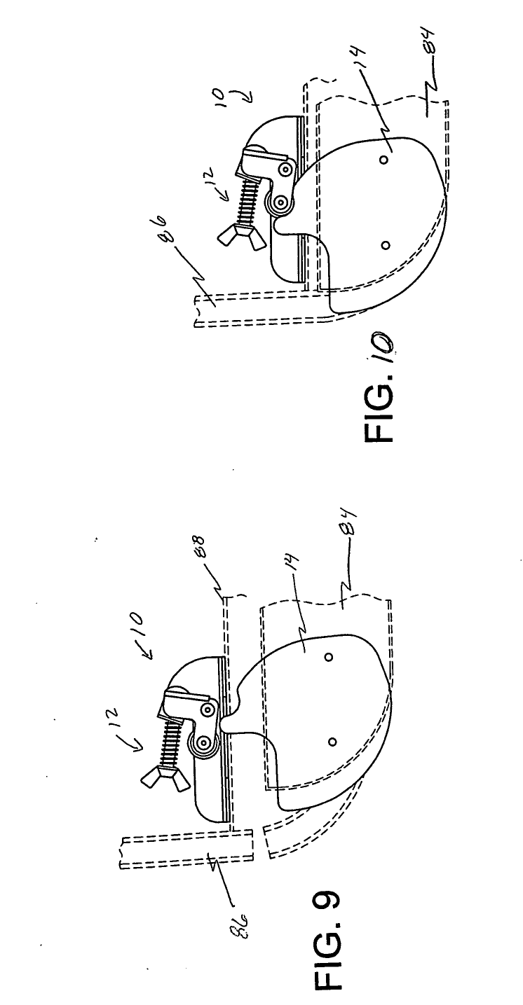

Referring to FIGS. 9 and 10, the detent latching system 10 is applied to a drawer 84 in a cabinet, dresser or other such enclosures 86. The detent assembly 12 is coupled to the door jam 88 of the cabinet 84 and the securing plate 14 is coupled to the drawer 84 in manners similar to that described above. Again a slot is formed in the door jam 88 that coincides with the detent access opening 40. As the drawer 84 is closed, the engagement portion 68 of the securing plate 14 encounters the detent 16 though the slot in the door jam 88 and the detent access opening 40 in the bottom plate 32 of the housing 20. The detent 16 moves along the traveling portion 72 of the curvilinear path 70 in a similar manner as that described above until the detent 16 comes to rest in the securing portion 74. This securement is reversed by applying an opening force to the drawer 84, also in a similar manner as described above.

The configuration of the detent assembly 12 and the securing plate 14 results in a compact arrangement that occupies a limited space within the cabinet. The locations of the detent assembly 12 and the securing plate 14, both when engaged and disengaged, do not interfere with storage areas or items stored in the storage area. In addition, the action of the securing member 22 during engagement of the detent 16 by the securing plate 14, is contained within the housing 20 of the detent assembly 12. Therefore, the action of the securing member 22 also does not interfere with storage areas or items stored in the storage areas.

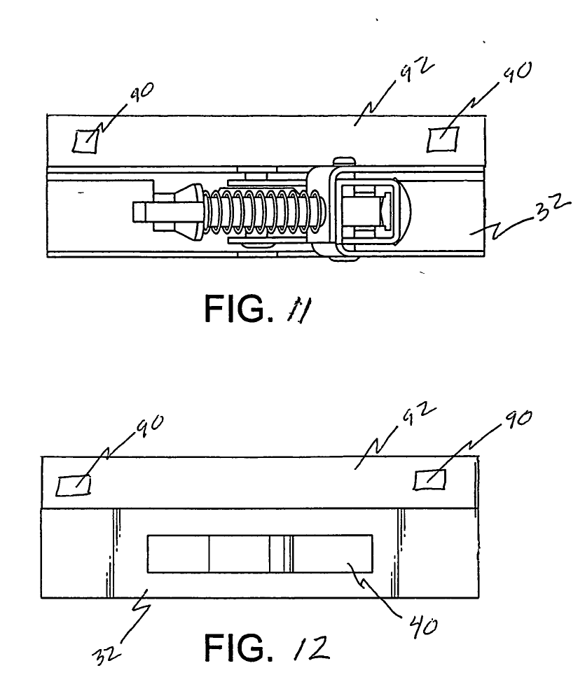

The methods of attachment of the detent assembly 12 to the cabinet 80, 86 and the securing plate 14 to the door 78 and drawer 84 as shown in FIGS. 7 through 10 are exemplary only. Any method that secures the detent assembly 12 and the securing plate 14 to either a generally stationary object, such as a cabinet, bureau, wall, etc., or a generally moveable object, such a door, drawer, or other enclosing member, is incorporated in the detailed invention. For instance, the embodiments shown in FIGS. 7 through 10 would be equally effective if the securing plate 14 were coupled to the cabinet 80, 86 and the detent assembly 12 were coupled to the door 78 or drawer 84. In another embodiment, the detent assembly 12 could be coupled to a cabinet 80, 86 through fastener openings 38 located in the side panels 30 of the housing 20. In addition, as shown in FIGS. 11 and 12, the bottom panel 32 of the housing can be extended so that fastener openings 90 are located in an extended portion 92 of the bottom panel 32 and not in line with the detent access opening 40 as shown in FIG. 4. In this configuration the extended portion 92 can be utilized to fasten the detent assembly 12 to a door jam of a cabinet, leaving the detent access opening 40 accessible above the door jam. This would eliminate the need for a slot to be included in the door jam and the securing plate 14 could access the detent assembly without having to pass through the door jam.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary. Still further, exemplary or representative values and ranges may be included to assist in understanding the present invention however, such values and ranges are not to be construed in a limiting sense.

1. A latching system comprising:
(a) a detent assembly comprising:
(i) a detent; and
(ii) a biasing member biasing the detent in a first direction; and
(b) a securing plate, the securing plate including a curvilinear portion, the curvilinear portion comprising:
(i) a detent traveling portion; and
(ii) a detent securing portion, located proximate to the detent traveling portion;
wherein, the detent traveling portion is adapted to engage the detent and encourage the detent towards a second direction, approximately opposite of the first direction, upon engagement with the detent;
further wherein, when the detent is in contact with the detent securing portion, the detent assembly is reversibly secured relative to the securing plate.

2. The latching system of claim 1, wherein the detent assembly is secured relative to the securing plate by the detent traveling portion being placed into contact with the detent and the securing plate being displaced towards the detent assembly until the detent is in contact with the detent securing portion.

3. The latching system of claim 2, wherein once the detent traveling portion contacts the detent, further displacement of the securing plate towards the detent assembly requires sufficient force be applied to the securing plate to move the detent in the second direction.

4. The latching system of claim 1, wherein the securement of the detent assembly relative to the securing plate is reversed when the detent is removed from contact with the securing plate by displacement of the securing plate away from the detent assembly.

5. The latching system of claim 4, wherein displacement of the securing plate away from the detent assembly requires sufficient force be applied to the securing plate to move the detent in the second direction.

6. The latching system of claim 1, wherein the biasing member is a linear spring.

7. The latching system of claim 1, wherein the detent is a rotatable cylinder.

8. The latching system of claim 1, further comprising:
(a) an enclosure, the enclosure comprising:
(i) a partially enclosed area; and
(ii) at least one opening to the partially enclosed area; and
(b) an enclosing member, which is moveable between at least two positions, a first position exposes the at least one opening of the enclosure and a second position covering the at least one opening in the enclosure;
wherein the curvilinear portion of the securing plate engages the detent as the enclosing member is moved for the first position to the second position and the curvilinear portion of the securing plate disengages the detent as the enclosing member is moved for the second position to the first position.

9. The latching system of claim 8, wherein the detent assembly is coupled to the enclosure and the securing plate is coupled to the enclosing member.

10. The latching system of claim 8, wherein the detent assembly is coupled to the enclosing member and the securing plate is coupled to the enclosure.

11. The latching system of claim 8, wherein when the enclosing member is in the second position, the detent assembly is secured relative to the securing plate, which secures the enclosing member relative to the enclosure.

12. The latching system of claim 11, wherein the enclosing member can be unsecured from the enclosure by applying a sufficient force to the enclosing member to move the enclosing member to the second position.

13. The latching system of claim 1, wherein a force in which the biasing member biases the detent in the first direction can be adjusted.

14. A latching system comprising:
(a) a detent assembly, the detent assembly comprising:
(i) a housing;
(ii) a detent;
(iii) a support member, including first, second, and third portions, pivotally coupled to the housing at the said first portion and coupled to the detent at the said second portion; and
(iv) a biasing member in contact with the support member at the said third portion; and
(b) a securing plate, the securing plate comprising:
(i) a detent traveling portion; and
(ii) a detent securing portion, located proximate to the detent traveling portion;
wherein the biasing member encourages the support member to pivot in a first direction and as the detent traveling portion engages the detent, the support member is encouraged to pivot in a second direction;
further wherein, when the detent is in contact with the detent securing portion, the detent assembly is reversibly secured relative to the securing plate.

15. The latching system of claim 14, wherein when the detent is in contact with the securing portion, the securement of the detent assembly relative to the securing plate is reversed by moving the securing plate away from the detent assembly.

16. The latching system of claim 15, wherein at least a gradually changing force is needed to move the securing plate away from the detent assembly.

17. The latching system of claim 14, wherein the detent assembly can be secured relative to the securing plate by moving the securing plate towards the detent assembly until the detent is in contact with the detent securing portion.

18. The latching system of claim 17, wherein at least a gradually changing force is needed to move the securing plate towards the detent assembly until the detent is in contact with the detent securing portion.

19. The latching system of claim 14, wherein the first portion of the support member is disposed between the second and third portions of the support member.

20. The latching system of claim 14, wherein the biasing member is a linear spring.

21. The latching system of claim 14, wherein the detent is a rotatable cylinder.

22. The latching system of claim 14, further comprising:
(a) an enclosure, the enclosure comprising:
(i) a partially enclosed area; and
(ii) at least one opening to the partially enclosed area; and
(b) an enclosing member, which is moveable between at least two positions, a first position exposes the at least one opening of the enclosure and a second position that covers the at least one opening in the enclosure;
wherein the curvilinear portion of the securing plate engages the detent as the enclosing member is moved for the first position to the second position and the curvilinear portion of the securing plate disengages the detent as the enclosing member is moved for the second position to the first position.

23. A latching system of claim 22, wherein the detent assembly is coupled to the enclosure and the securing plate is coupled to the enclosing member.

24. A latching system of claim 22, wherein the detent assembly is coupled to the enclosing member and the securing plate is coupled to the enclosure.

25. The latching system of claim 22, wherein when the enclosing member is in the second position, the detent assembly is secured relative to the securing plate, which secures the enclosing member relative to the enclosure.

26. The latching system of claim 14, wherein a force in which the biasing member encourages the support member to pivot in the first direction is adjustable.

27. A cabinet for storage comprising:
(a) an enclosable area;
(b) an enclosing member, moveable between at least two positions, a first position that exposes the enclosable area and a second location that encloses the enclosable area;
(c) a detent assembly comprising;
(i) a detent; and
(ii) a biasing member, biasing the detent in a first direction; and
(d) a securing plate including a curvilinear portion, the curvilinear portion comprising:
(i) a detent traveling portion, and
(ii) a detent securing portion, located proximate to the detent traveling portion;
wherein, the securing plate is arranged to engage with the detent as the enclosing member is moved from the first position to the second position and encourages the detent to move in a second direction upon engagement;
further wherein, when the enclosing member locates in the second position the detent is in contact with the securing portion, and the enclosing member is reversibly secured relative to the enclosable area.

28. The cabinet for storage as in claim 27, wherein the detent assembly is located within the enclosable area and the securing plate is coupled to the enclosing member.

29. The cabinet for storage as in claim 27, wherein the detent assembly is coupled to the enclosing member and the securing plate is located within the enclosable area.

30. The cabinet for storage of claim 27, wherein the distance needed to move the enclosing member from the first position to the second position includes a portion where the force needed to move the enclosing member from the first position to the second position changes gradually.

31. The cabinet for storage of claim 27, wherein the securement of the enclosing member to the enclosable area is reversed by apply a force to the enclosing member to disengage the securing plate from the detent.

32. The cabinet for storage of claim 31, wherein the distance needed to move the enclosing member from the second position to the first position includes a portion where the force needed to move the enclosing member from the second position to the first position changes gradually.

33. The cabinet for storage of claim 27, wherein a force in which the biasing member biases the detent in a first direction is adjustable.

34. A cabinet for garage storage comprising:
(a) an enclosable area;
(b) an enclosing member, moveable between at least two positions, a first position that exposes the enclosable area and a second location that encloses the enclosable area;
(c) a detent assembly comprising;
(i) a detent; and
(ii) a biasing member biasing the detent; and
(d) a securing plate arranged to engage with the detent.
